(19) United States
(12) Patent Application Publication
(10) Pub. No.: US 2025/0327633 A1
(43) Pub. Date: Oct. 23, 2025

(54) HEAT EXCHANGER AND METHOD OF MANUFACTURING THE SAME

(71) Applicant: Hanon Systems, Daejeon (KR)

(72) Inventors: Young Sam KIM, Daejeon (KR); Hyuk KIM, Daejeon (KR); Jong Du LEE, Daejeon (KR); Young Kook HWANG, Daejeon (KR)

(73) Assignee: Hanon Systems, Daejeon (KR)

(21) Appl. No.: 19/088,743

(22) Filed: Mar. 24, 2025

(30) Foreign Application Priority Data
Apr. 18, 2024 (KR) 10-2024-0051934

(51) Int. Cl. F28F 9/00; F28F 9/02

(52) U.S. Cl. CPC F28F 9/001; F28F 9/0246; F28F 2255/00

(57) ABSTRACT

The present disclosure is directed to provide a heat exchanger and a method of manufacturing the same, which are capable of, in a high-temperature environment, improving the effect of suppressing tube damage caused by the heat load by improving the shape of a saw-cut formed on a support to suppress tube damage caused by a heat load while also allowing the heat exchanger to be manufactured using existing equipment, thereby preventing an increase in the production costs. More specifically, an object of the present disclosure is to provide a heat exchanger and a method of manufacturing the same, in which the shape of the saw-cut formed on the support is formed of two types, an I-shaped cut portion and a Z-shaped cut portion, and the I-shaped cut portion is formed at the center, while a pair of Z-shaped cut portions are formed symmetrically and biased toward the both ends.

### CROSS REFERENCE TO RELATED APPLICATION

The present application claims priority to Korean Patent Application No. 10-2024-0051934, filed on Apr. 18, 2024, the entire contents of which are incorporated herein for all purposes by this reference.

### BACKGROUND OF THE INVENTION

### Field of the Invention

The present disclosure relates to a heat exchanger and a method of manufacturing the same, and more specifically, to a heat exchanger with an improved support shape that is capable of suppressing tube damage caused by thermal load, as well as a method of manufacturing the same.

### Description of the Related Art

In general, not only components such as an engine for operating a vehicle are provided in an engine room of the vehicle, but also various heat exchangers such as a radiator, an intercooler, an evaporator, and a condenser for cooling the components such as the engine in the vehicle or adjusting an air temperature in an interior of the vehicle are provided in the engine room of the vehicle. In general, heat exchange media flow in the heat exchangers. The heat exchange medium in the heat exchanger exchanges heat with outside air present outside the heat exchanger, such that the cooling operation or the heat dissipation is performed.

The radiator serves to cool a drive device by allowing a high-temperature coolant, which is made by absorbing heat, to exchange heat with outside air. That is, the radiator forms a significantly high-temperature environment during operation, and accordingly, substantial thermal deformation occurs in the components that make up the radiator. Typically, the radiator is structured in the form of a conventional heat exchanger consisting of a tank and tubes, where the tank and tubes are brazed together. However, when thermal expansion occurs due to the formation of a high-temperature environment, during the expansion process of the tank and tubes, respectively, stress is concentrated at the joint portions therebetween. When fatigue accumulates due to this stress concentration, it may lead to failure.

In order to address the issue of stress concentration on the tubes due to thermal deformation, research from various perspectives has been conducted. In particular, in case of a heat exchanger in which the temperature of the heat exchange medium circulating through each core consisting of each row of tubes as a two-row heat exchanger is formed differently, research has been conducted to alter the tube configuration at portions where the temperature difference is particularly concentrated, or to improve the overall tank shape. These studies have shown promising results. However, this configuration cannot be applied to a single-row heat exchanger where a single heat exchange medium is circulated, and therefore, research into a heat stress improvement structure suitable for this is required.

Meanwhile, it is common for a radiator to further include support components that serve to support the connection between the tank and the tubes. Specifically, in a heat exchanger including a pair of header tanks spaced apart by a predetermined distance from each other to be arranged in parallel, and a plurality of tubes fixed at both ends to the pair of header tanks to form a flow path for the refrigerant, a support may be provided, extending parallel to the tubes on the outermost side of the tube array and connected to the header tank. That is, the support serves to securely hold the pair of header tanks, and as the support reinforces the bearing strength, the stress applied to the joint portions of the tubes may be reduced. Meanwhile, in a high-temperature environment where all components undergo thermal expansion, the header tank and tubes, which are in direct contact with the heat exchange medium, experience significant deformation. In contrast, since the support does not directly contact the heat exchange medium, its deformation is relatively small. As a result, while there is an advantage in that the distance between the pair of header tanks is stably maintained by the support, the distance between the header tanks is maintained even as the header tanks and tubes expand. This may lead to a negative effect, where stress is more concentrated on the joint portions of the tubes.

Meanwhile, a shape structure that can respond to external stimuli is applied to the support as well. As an example, Japanese Patent Publication No. 2023-085668 (“Radiator Support for Automobiles,” 2023 Jun. 21) discloses a radiator support configuration that suppresses in specific portions while reducing production costs. Additionally, Japanese Patent No. 7147111 (“Radiator Support,” 2022 Sep. 27) discloses a radiator support configuration that suppresses resonance of members caused by vehicle driving vibrations. As such, research is being actively conducted to even provide the support with functionality to perform special roles.

In this context, a support with a saw-cut applied is being used as a support to alleviate tube stress concentration caused by thermal load. FIG. 1 illustrates various embodiments of a heat exchanger equipped with a conventional saw-cut support. As illustrated in FIG. 1, the heat exchanger itself equipped with a support is a conventional heat exchanger that includes a header tank and tubes. In the upper view of FIG. 1, the case where there is one saw-cut in the support is illustrated, while in the lower view of FIG. 1, the case where there are two saw-cuts in the support is illustrated. The saw-cut allows for a slight clearance in distance, and accordingly, even if thermal expansion or other factors occur, the clearance formed by the saw-cut in the support may absorb the expansion of other components. In other words, the saw-cut allows for the effect of suppressing tube damage caused by thermal load.

The saw-cut can be further explained as follows. A saw-cut support, as the name suggests, refers to a support that has been cut using a saw. Initially, the entire support is formed as a single piece until the support is made into a single piece, then a rotary saw machine cuts the support into two pieces while it is still assembled in the heat exchanger. In this case, since the rotary saw must not damage the tubes of the heat exchanger, the support has a specific structure that allows the saw cut to be performed smoothly while avoiding damage to the tubes at the position where the saw cut is to be made. FIG. 2 illustrates a saw-cut manufacturing method on a general support. In a single-piece manufacturing process, as illustrated in the upper view, an I-shaped hole is first formed on a flat plate, and then the side portions of the flat plate are bent to complete the manufacture of the support as a single piece. That is, up to this point, the support is entirely in one piece. At the next stage (which is omitted in the drawing), the support is assembled into the heat exchanger. At this point, as illustrated in the middle view, the thin connecting portions at both ends of the I-shaped hole are cut using a rotary saw blade. In this process, the rotary saw blade only needs to move near the end of the area where the side portion of the support protrudes. As a result, it does not encroach upon the area where the heat exchanger tubes are located, ensuring that the tubes are safely protected from damage. After the cutting process, as illustrated in the lower view, the support is split into two pieces, completing the manufacture of the saw-cut support.

In this case, the fewer the number of saw-cuts, the less the amount of absorption, so it is natural that the heat damage suppression effect will be reduced. However, on the contrary, as the number of saw-cuts increases, the structural rigidity of the support itself weakens, which raises concerns that the support's primary function, that is, the function of maintaining and supporting the distance between the header tanks, may be compromised. Considering these factors, it is empirically known that forming up to 2 to 3 saw-cuts is appropriate.

In case where only a single saw-cut is formed, as illustrated in FIG. 1, the heat damage suppression effect may not be sufficiently achieved. Therefore, it is preferable to increase the number of saw-cuts. However, in actual production environments, it is not easy to simply apply changes that increase the number of saw-cuts. To be more specific, for the manufacture of a single saw-cut, a single rotary saw equipment would be installed. However, to manufacture two saw-cuts, it would be necessary to purchase and install an additional rotary saw equipment. Alternatively, in order to perform two cutting processes with a single rotary saw equipment, additional equipment may be required to move either the rotary saw or the support (heat exchanger with the support assembled). That is, in the production environment, increasing the number of saw-cuts inevitably incurs additional equipment costs, which leads to an increase in production costs.

### Documents of Related Art

(Patent Document 1) Japanese Patent Publication No. 2023-085668 (“Radiator Support for Automobiles,” 2023 Jun. 21).
(Patent Document 2) Japanese Patent No. 7147111 (“Radiator Support,” 2022 Sep. 27).

### SUMMARY OF THE INVENTION

Therefore, the present disclosure has been made in an effort to solve the problems of the related art as described above. An object of the present disclosure is to provide a heat exchanger and a method of manufacturing the same, which are capable of, in a high-temperature environment, improving the shape of a saw-cut formed on a support to enhance the thermal load tube damage suppression effect in order to suppress tube damage caused by thermal load, while enabling manufacturing using existing equipment, thereby preventing an increase in production costs. More specifically, an object of the present disclosure is to provide a heat exchanger and a method of manufacturing the same, in which the shape of the saw-cut formed on the support is formed of two types, an I-shaped cut portion and a Z-shaped cut portion, and the I-shaped cut portion is formed at the center, while a pair of Z-shaped cut portions are formed symmetrically and biased toward the both ends.

To achieve the aforementioned the objects as described above, there is provided a heat exchanger 100, according to the present disclosure. The heat exchanger 100 may include a pair of header tanks 110, each having a header and a tank coupled together to form a fluid flow space inside, and spaced apart by a predetermined distance from each other to be arranged in parallel, and a plurality of tubes 120, each having both ends fixed to the header tanks 110 to form a flow path for a heat exchange medium, in which the heat exchanger 100 may include a pair of supports 150 disposed on an outermost side of a tube array, which is formed by fixing both ends of the tubes to the header tanks 110 and arranging the tubes 120, to support the tube array, and in which the support may include a single I-shaped cut portion 153 and a plurality of Z-shaped cut portions 154, which separate the support 150 into a plurality of portions.

In this case, the support 150 may include a bottom portion 151 extending in a length direction and formed in a plane of the length direction and a width direction, and a pair of side portions 152 extending in the length direction and bent from both ends of the bottom portion 151 in the width direction toward an outside of the heat exchanger 100, formed in a plane of the length direction and a height direction, in which an extension direction of the tubes 120 is referred to as the length direction, an arrangement direction of the tubes 120 is referred to as the height direction, and a direction perpendicular to both the length direction and the height direction is referred to as the width direction.

In addition, the I-shaped cut portion 153 may include an I-shaped hole 153a formed in the entire bottom portion 151 and a part of the side portion 152, and a cut portion 153b formed by cutting a remaining part of the side portion 152 within a range of the length direction in which the I-shaped hole 153a is formed.

In addition, the Z-shaped cut portion 154 may include a Z-shaped hole 154a formed in the entire bottom portion 151 and a part of the side portion 152, and a bent portion 154b formed by bending a remaining part of the side portion 152 within the range of the length direction in which the Z-shaped hole 154a is formed.

In addition, in the Z-shaped cut portion 154, the bent portion 154b may be bent toward an inner side of a space formed by the pair of side portions 152.

In addition, in the support 150, when one end of the support 150 in the length direction is defined as 0% and the other end is defined as 100%, the I-shaped cut portion 153 may be formed at a 50% position of the support 150, and the Z-shaped cut portion 154 may be formed at positions symmetrical to each other in a pair with respect to the I-shaped cut portion 153.

In addition, the Z-shaped cut portion 154 on one side of the support 150 may be formed at a position within a range of 25% to 30% of the support 150.

In addition, in the support 150, an inclined direction of a hole shape of the Z-shaped hole 154a included in each of the pair of Z-shaped cut portions 154 may be either the same for both, formed as line symmetry with respect to the I-shaped cut portion 153, or formed as point symmetry with respect to a center of the I-shaped cut portion 153.

In addition, in the heat exchanger 100, the inclined direction of the hole shape of the Z-shaped hole 154a included in the Z-shaped cut portion 154 formed on each support 150 may be formed in opposite directions, with respect to the pair of supports 150 included in the heat exchanger 100.

In addition, a height Hz of a part of the Z-shaped hole 154a formed over a part of the side portion 152 may be formed smaller than a height H_{I} of a part of the I-shaped hole 153a formed over a part of the side portion 152.

In addition, a length L_{z}of a part of the Z-shaped hole 154a formed over a part of the side portion 152 may be formed greater than a length L_{I} of a part of the I-shaped hole 153a formed over a part of the side portion 152.

In addition, the heat exchanger 100 may be a radiator.

Further, there is provided a method of manufacturing the heat exchanger as described above, according to the present disclosure. The method may include: a hole formation step, in which the I-shaped hole 153a and the Z-shaped hole 154a are formed on a flat plate including the bottom portion 151 and the pair of side portions 152; a bending formation step, in which the remaining part of the side portion 152 within a range of the length direction where the Z-shaped hole 154a of the support 150 is formed is bent to form the bent portion 154b; a single piece completion step, in which the pair of side portions 152 are bent, completing the manufacture of the support 150 as a single piece; a heat exchanger assembly step, in which the header tanks 110, the tubes 120, and the support 150 are assembled; a saw-cut formation step, in which the remaining part of the side portion 152 within a range of the length direction where the I-shaped hole 153a of the support 150 is formed is cut to form the cut portion 153b.

### BRIEF DESCRIPTION OF THE DRAWINGS

FIG. 1 illustrates various embodiments of a saw-cut heat exchanger.

FIG. 2 illustrates a saw-cut manufacturing method on a general support.

FIG. 3 is a perspective view of a support according to the present disclosure.

FIG. 4 is an enlarged perspective view and side view of a part of the support according to the present disclosure.

FIG. 5 is a top view of the support according to the present disclosure.

FIG. 6 is an enlarged top view of a part of the support during the manufacturing process, before bending, according to the present disclosure.

FIG. 7 illustrates a manufacturing method of an I-shaped cut portion. FIG. 8 illustrates a manufacturing method of a Z-shaped cut portion.

FIG. 9 illustrates various embodiments of the support according to the present disclosure.

### DETAILED DESCRIPTION OF THE INVENTION

Hereinafter, a heat exchanger and a method of manufacturing the same according to the present disclosure, having the configuration as described above, will be explained in detail with reference to the attached drawings.

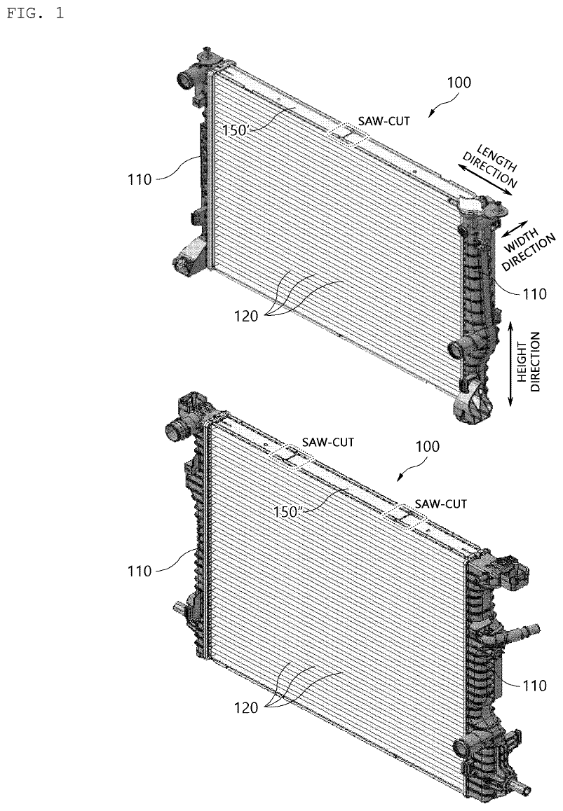

The heat exchanger 100 of the present disclosure, as previously described, has a configuration that is almost identical to that of a conventional heat exchanger, except that the shape and manufacturing method of a support 150 are different. That is, the overall structure of the heat exchanger 100 of the present disclosure is similar to that illustrated in FIG. 1, including a pair of header tanks 110, each having a header and a tank coupled together to form a fluid flow space inside, and spaced apart by a predetermined distance from each other to be arranged in parallel, and a plurality of tubes 120, each having both ends fixed to the header tank 110 to form a flow path for a heat exchange medium. Although not illustrated in the drawing, heat dissipation fins may be interposed between the tubes 120 to enhance the heat exchange performance. Additionally, the heat exchanger 100 of the present disclosure includes a pair of supports 150 disposed on an outermost side of a tube array, which is formed by fixing both ends of the tubes 120 to the header tank 110 and arranging the tubes, to support the tube array. In more detail, the heat exchanger 100 of the present disclosure aims to suppress tube damage caused by thermal load by improving the shape of the support 150. It is assumed that the heat exchanger 100 operates in a high-temperature environment, and as a representative example of such a heat exchanger, it may be a radiator.

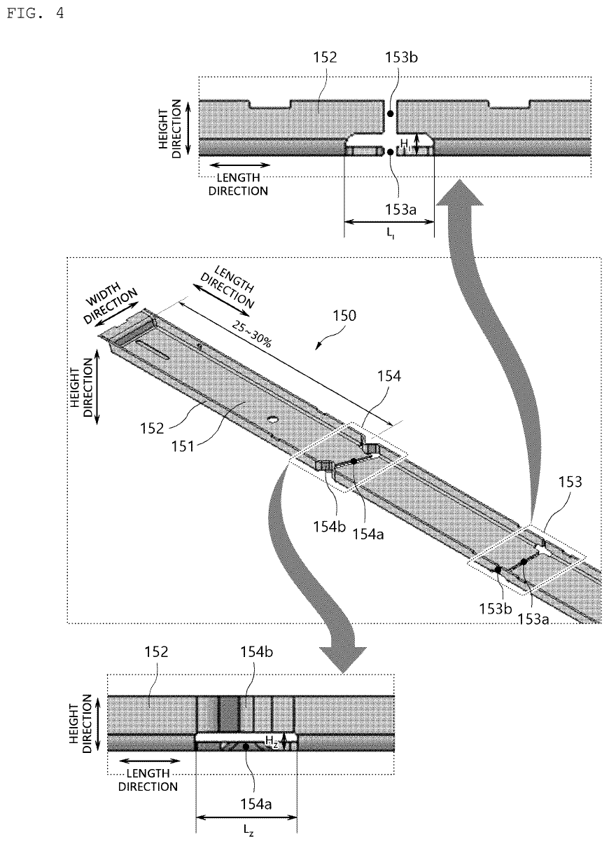

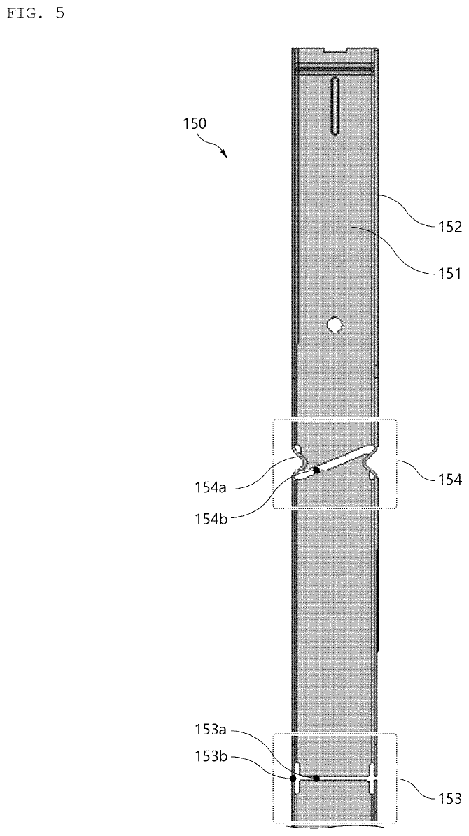

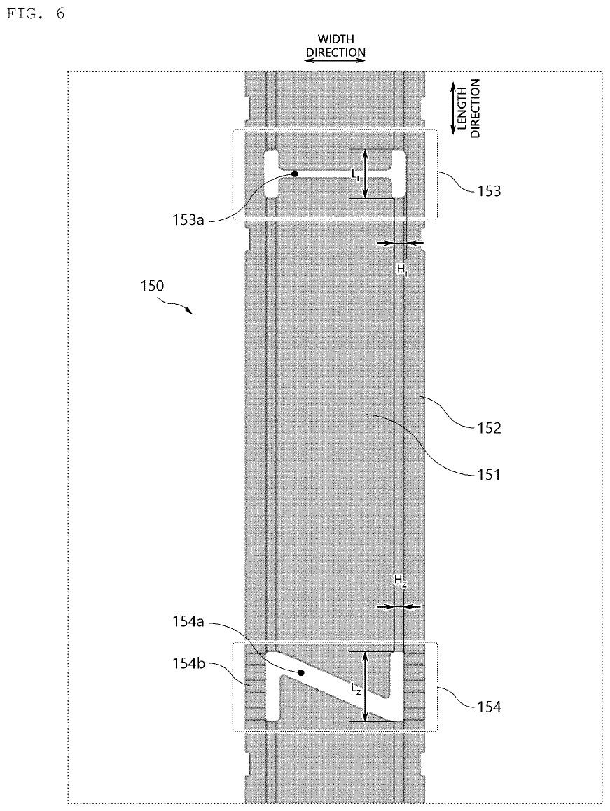

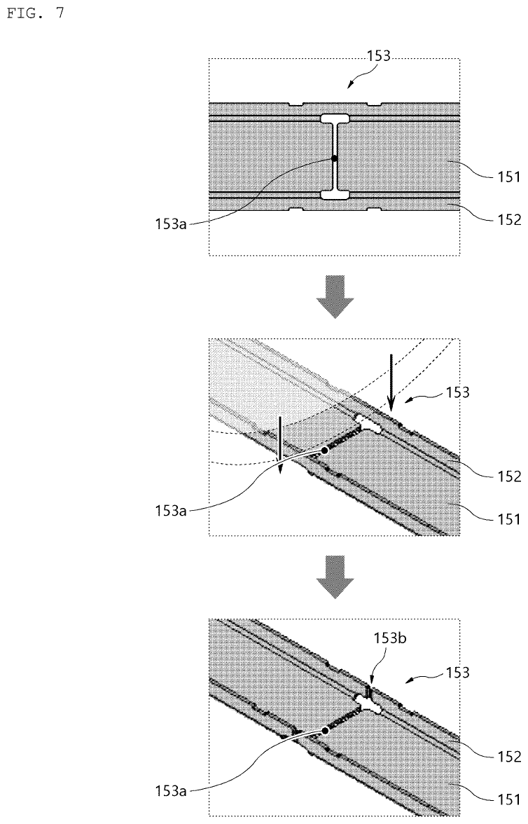

In this case, the support 150 of the present disclosure includes a single I-shaped cut portion 153 and a plurality of Z-shaped cut portions 154, which separate the support 150 into a plurality of portions. FIG. 3 is a perspective view of the support according to the present disclosure, and FIG. 4 is an enlarged perspective view and side view of a part of the support according to the present disclosure. Additionally, FIG. 5 is a top view of the support according to the present disclosure, and FIG. 6 is an enlarged top view of a part of the support during the manufacturing process, before bending, according to the present disclosure. With reference to FIGS. 3 to 6, the configuration of the heat exchanger of the present disclosure, particularly the support 150, will be explained in more detail.

The basic shape of the support 150 will be described as follows. The support 150 includes a bottom portion 151 and a pair of side portions 152. When an extension direction of the tubes 120 is referred to as a length direction, an arrangement direction of the tubes 120 is referred to as a height direction, and a direction perpendicular to both the length direction and the height direction is referred to as a width direction, the bottom portion 151 extends in the length direction and is formed in a plane of the length direction and the width direction. In addition, the pair of side portions 152 extend in the length direction and are bent from both ends of the bottom portion 151 in the width direction toward the outside of the heat exchanger 100, forming a plane in the length direction and the height direction.

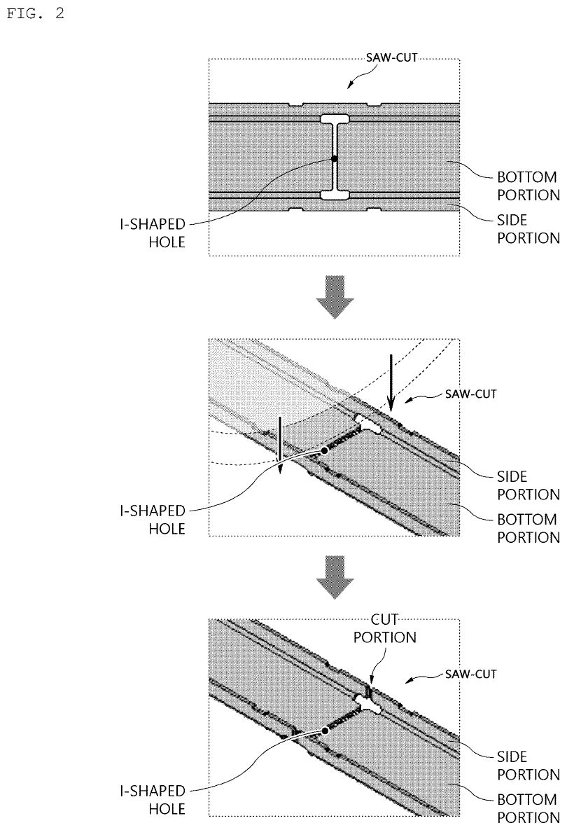

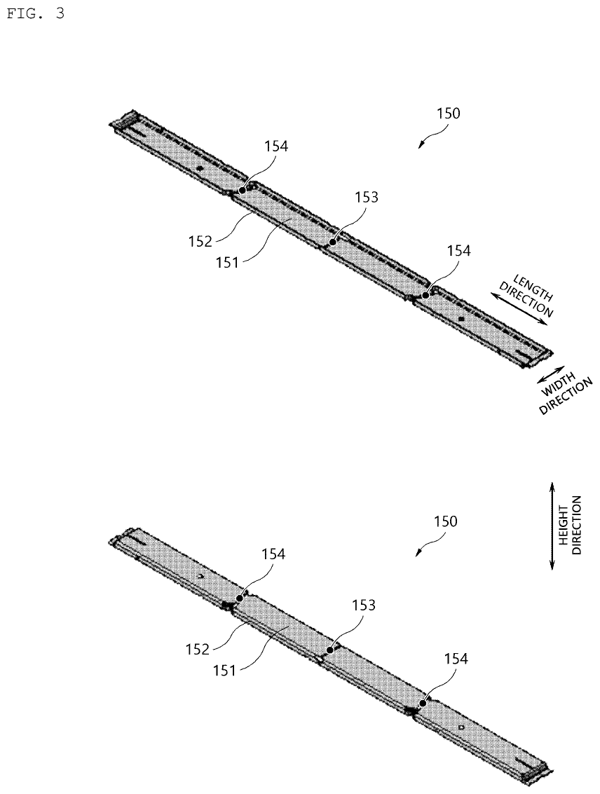

As described above, in the present disclosure, a single I-shaped cut portion 153 and a plurality of Z-shaped cut portions 154 are formed on the support 150. In this case, the I-shaped cut portion 153 is of the same shape as the conventional saw-cut illustrated in the related art drawings, FIG. 1 and FIG. 2. That is, the I-shaped cut portion 153 (similar to the conventional saw-cut) serves to separate the support 150 into a plurality of portions. Meanwhile, the Z-shaped cut portion 154, as will be explained in more detail below, does not serve to separate the support 150 unlike the I-shaped cut portion 153. However, through its structural characteristics, it may achieve a similar effect to the I-shaped cut portion 153 in suppressing tube damage caused by thermal load.

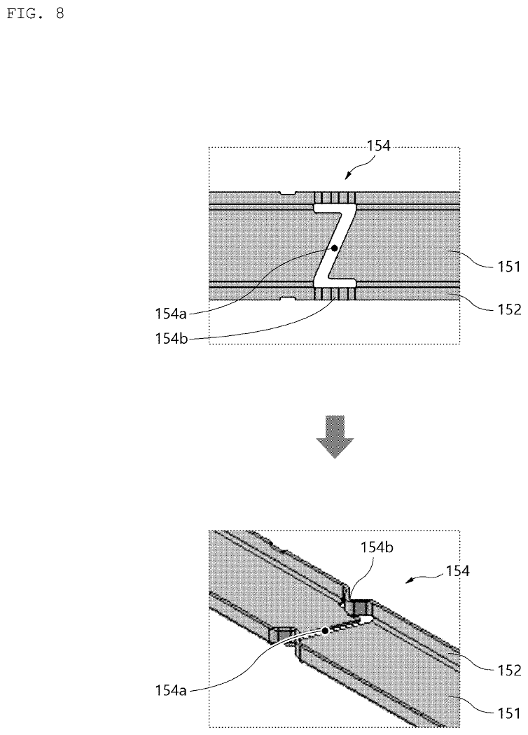

The shape of the I-shaped cut portion 153 will be explained in detail as follows. The I-shaped cut portion 153 primarily includes an I-shaped hole 153a and a cut portion 153b. The I-shaped hole 153a is formed across the entire bottom portion 151 and a part of the side portion 152. Since the hole shape is in the form of an “I,” it is intuitively referred to as the “I-shaped hole.” Specifically, the I-shaped hole 153a includes a pillar portion extending in the width direction, and a pair of protrusions protrudingly extending in the length direction from both ends of the pillar portion in the width direction, forming a serif shape of the “I.” As illustrated in the top view of FIG. 6 (before bending of the side portion), the pillar portion is entirely included within the bottom portion 151, while the protrusions extend over a portion where bends from the bottom portion 151 to the side portion 152. FIG. 7 illustrates a manufacturing method of the I-shaped cut portion, and this shape can be confirmed in the upper view of FIG. 7.

In the state as illustrated in FIG. 6, when the side portion 152 is bent to the state illustrated in the side view of FIG. 4, the remaining portion of the side portion 152 within a range of the length direction where the I-shaped hole 153a is formed becomes the only connecting portion that connects the two portions on both sides with respect to the position where the I-shaped hole 153a is formed. That is, as can be seen in the side view of FIG. 4, a part of the side portion 152 toward the bottom portion 151 is formed as an empty space.

In this state, as illustrated in the middle view of FIG. 7, the connecting portion is cut using a rotary saw, thereby forming the cut portion 153b. That is, the cut portion 153b is formed by cutting the remaining portion of the side portion 152 within a range of the length direction where the I-shaped hole 153a is formed. Thus, by the I-shaped hole 153a and the cut portion 153b, the support 150 is completely separated into two portions at the position of the I-shaped cut portion 153.

When the support 150 is separated into two portions in this way, a slight gap is formed between each portion separated by the I-shaped cut portion 153. This gap not only effectively blocks heat transfer due to conduction, but also can effectively suppress stress concentration at the tube-header tank coupling portion, even when thermal expansion occurs. That is, in case of a support without such a saw-cut, since the support is supporting the spacing distance between the header tanks while both the tubes and header tanks expand, stress concentrated at the tube-header tank coupling portion results in the tube being damaged. However, when a saw-cut is present, even if the spacing distance between the header tanks changes, it is possible to respond flexibly due to the clearance of the gap space, and thus the stress concentration at the tube-header tank coupling portion can be effectively suppressed.

The shape of the Z-shaped cut portion 154 will be explained in detail as follows. The Z-shaped cut portion 154 primarily includes a Z-shaped hole 154a and a bent portion 154b. The Z-shaped hole 154a is formed across the entire bottom portion 151 and a part of the side portion 152. Since the hole shape is in the form of a “Z,” it is intuitively referred to as the “Z-shaped hole.” Specifically, the Z-shaped hole 154a includes an inclined portion extending inclined in both the width direction and length direction, and a pair of extending portions formed in the form of upper and lower strokes of the “Z” shape extending in the length direction from both ends of the inclined portion in the width direction. As illustrated in the top view of FIG. 6 (before bending of the side portion), the inclined portion is entirely included within the bottom portion 151, while the extending portions extend over a portion where bends from the bottom portion 151 to the side portion 152. FIG. 8 illustrates a manufacturing method of the Z-shaped cut portion, and this shape can be confirmed in the upper view of FIG. 8.

In the state as illustrated in FIG. 6, when the side portion 152 is bent to the state illustrated in the side view of FIG. 4, the remaining portion of the side portion 152 within a range of the length direction where the Z-shaped hole 154a is formed becomes the connecting portion that connects the two portions on both sides with respect to the position where the Z-shaped hole 154a is formed. That is, as can be seen in the side view of FIG. 4, a part of the side portion 152 toward the bottom portion 151 is formed as an empty space.

As such, when bending the side portion 152, the bending shape for the bent portion 154b may be integrally formed on a block for bending the side portion. That is, the bent portion 154b is formed by bending the remaining portion of the side portion 152 within a range of the length direction where the Z-shaped hole 154a is formed. In this case, the Z-shaped hole 154a separates the support 150, but the bent portion 154b remains connected while being bent. That is, at the position of the Z-shaped cut portion 154, the support 150 is not completely separated and remains connected by the bent portion 154b. Meanwhile, in this case, it is preferable for the Z-shaped cut portion 154 to be bent such that the bent portion 154b faces the inner side of the space formed by the pair of side portions 152. When the bent portion 154b is bent to face the outer side, there is a risk that it may protrude beyond the original volume of the heat exchanger, potentially causing interference with other external components.

It was explained above that in case of the I-shaped cut portion 153, the support 150 is completely separated and a gap is formed, which has the effect of suppressing tube damage caused by thermal expansion in a high-temperature environment. In case of the Z-shaped cut portion 154, although each portion separated by the Z-shaped hole 154a is connected by the bent portion 154b, a slight gap caused by the Z-shaped hole 154a is still formed. That is, at the position of the Z-shaped cut portion 154, the support 150 is formed in a manner that is almost separated into two portions, but is connected only by the bent portion 154b, which has a relatively very narrow width. As a result, the gap prevents heat transfer by conduction, and since the bent portion 154b has a relatively very narrow width, conduction cannot occur actively. This effectively suppresses overall conductive heat transfer, allowing for a similar effect to the I-shaped cut portion 153. Furthermore, when the spacing distance between the header tanks changes due to thermal expansion, the bent portion 154b deforms elastically and flexibly. The Z-shaped hole 154a forms a gap space, thereby creating an effect similar to the I-shaped cut portion 153. This allows the Z-shaped cut portion 154 to effectively suppress stress concentration at the tube-header tank coupling portion without the need for cuts, achieving an effect almost identical to the I-shaped cut portion 153.

In this way, although no actual cutting occurs, the Z-shaped cut portion 154 can provide a tube damage suppression effect almost identical to the I-shaped cut portion 153. In this case, as described above, in order to form a saw-cut such as the I-shaped cut portion 153 on the support, a rotary saw machine is required as manufacturing equipment. To increase the number of saw-cuts, the number of rotary saw machines must also be increased, which leads to the issue of rising production costs due to increased equipment costs. However, the Z-shaped cut portion 154 can achieve an effect almost identical to the I-shaped cut portion 153, while not requiring a cutting process. Therefore, by applying the configuration of the present disclosure, a significant effect can be achieved in improving the thermal load response performance of the support 150 without the burden of increased equipment costs and production costs.

To maximize the thermal load response performance, it is preferable to appropriately mix and dispose the I-shaped cut portion 153 and the Z-shaped cut portion 154. The I-shaped cut portion 153 corresponds to the case where a single saw-cut is formed, as illustrated in the upper view of FIG. 1. When one end of the support 150 in the length direction is defined as 0% and the other end is defined as 100%, it is assumed that the I-shaped cut portion 153 is formed at the 50% position of the support 150.

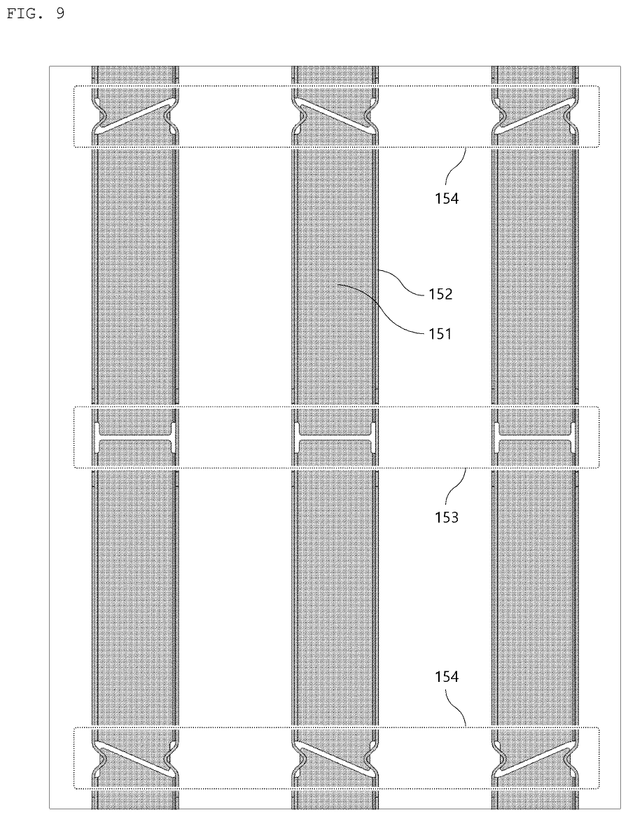

In this case, it is preferable for the pair of Z-shaped cut portions 154 to be formed symmetrically on either side of the I-shaped cut portion 153. Additionally, it is preferable for the Z-shaped cut portions 154 of one side to be formed at a position within a range of 25% to 30% of the support 150, as illustrated in FIG. 4. That is, the various portions of the support 150 separated by the I-shaped cut portion 153 and the Z-shaped cut portion 154 are made to have similar lengths. FIG. 9 illustrates various embodiments of the support according to the present disclosure. As illustrated, the inclined direction of the hole shape of the Z-shaped hole 154a, included in each of the pair of Z-shaped cut portions 154, may be either the same for both (middle embodiment), formed in a line symmetry with respect to the I-shaped cut portion 153 (left embodiment), or formed in a point symmetry with respect to the center of the I-shaped cut portion 153 (right embodiment).

Additionally, not only the inclined direction of the Z-shaped hole 154a on the single support 150, but also the inclined direction of the Z-shaped hole 154a in the pair of supports 150 included in the heat exchanger may be considered. In this case, the inclined direction of the hole shape of the Z-shaped hole 154a, included in the Z-shaped cut portion 154 formed on each support 150, may be made formed to be opposite to each other. As described above, the I-shaped cut portion 153 and the Z-shaped cut portion 154 may be considered as a type of damage structure (even though they are intentionally formed as required). Therefore, when such damage structures are repeatedly formed in the same form, there is a concern that the structural stability may be excessively compromised. With this taken into consideration, by forming the inclined direction of the Z-shaped hole 154a in a misaligned manner in each of the supports 150 provided on the upper and lower sides, the loss of structural stability can be appropriately reduced.

Meanwhile, in FIG. 4 and FIG. 6, the heights/lengths of a part of the I-shaped hole 153a and a part of the Z-shaped hole 154a formed over a part of the side portion 152 are shown. Specifically, the height of the part of the I-shaped hole 153a formed over a part of the side portion 152 is denoted as H_{I}, and the length thereof is denoted as L_{I}. The height of the part of the Z-shaped hole 154a formed over a part of the side portion 152 is denoted as H_{Z}, and the length thereof is denoted as L_{Z}.

As described above, in case of the I-shaped cut portion 153, the I-shaped hole 153a is formed across the entire bottom portion 151 and a part of the side portion 152. The remaining portion of the side portion 152 within a range of the length direction where the I-shaped hole 153a is formed is cut, and the cut portion 153b is formed. Meanwhile, in case of the Z-shaped cut portion 154, the Z-shaped hole 154a is formed across the entire bottom portion 151 and a part of the side portion 152. The remaining portion of the side portion 152 within a range of the length direction where the Z-shaped hole 154a is formed is bent, and the bent portion 154b is formed. That is, when viewed from the side portion 152, in the I-shaped cut portion 153, it is advantageous for the I-shaped hole 153a to be formed with a larger height, leaving only a small portion to be cut. In contrast, in the Z-shaped cut portion 154, it is advantageous for the Z-shaped hole 154a to be formed with a smaller height so that the bent portion 154b has an appropriate height, ensuring it is not weakened too much.

To summarize these points as a relative comparison between the I-shaped hole 153a and the Z-shaped hole 154a, it can be stated as follows. As explicitly illustrated in FIG. 4 and FIG. 6, it is preferable for the height H_{Z} of the part of the Z-shaped hole 154a formed over a part of the side portion 152 to be formed smaller than the height H_{I} of the part of the I-shaped hole 153a formed over a part of the side portion 152.

Meanwhile, from the length perspective, in case of the I-shaped cut portion 153, the I-shaped hole 153a only needs to have a length sufficient to avoid process errors during the rotary saw cutting process, so it does not need to be formed excessively long. In contrast, in case of the Z-shaped cut portion 154, considering that the amount of portion corresponding to the length of the Z-shaped hole 154a is bent and deformed through pressing to form the bent portion 154b, when it is formed too short, problems such as excessive stretching and breakage during the deformation process may occur. That is, the Z-shaped hole 154a is preferably formed sufficiently long in the length direction.

To summarize these points also as a relative comparison between the I-shaped hole 153a and the Z-shaped hole 154a, it can be stated as follows. As explicitly illustrated in FIG. 4 and FIG. 6, it is preferable for the length L_{Z} of the part of the Z-shaped hole 154a formed over a part of the side portion 152 to be formed greater than the length LI of the part of the I-shaped hole 153a formed over a part of the side portion 152.

The method of manufacturing the heat exchanger of the present disclosure is summarized as follows. The method of manufacturing the heat exchanger of the present disclosure may include a hole formation step, a bending formation step, a single piece completion step, a heat exchanger assembly step, and a saw-cut formation step.

In the hole formation step, the I-shaped hole 153a and the Z-shaped hole 154a are formed on a flat plate that includes the bottom portion 151 and the pair of side portions 152. That is, a shape as illustrated in FIG. 6 is formed on the flat plate.

In the bending formation step, the remaining portion of the side portion 152 within a range of the length direction where the Z-shaped hole 154a of the support 150 is formed is bent, and the bent portion 154b is formed. This step may be integrated with the single piece completion step that will be described below, where the shape used for forming the bent portion 154b on a pressing block for bending the side portion 152 is formed integrally, thus forming a set with the single piece completion step.

In the single piece completion step, the pair of side portions 152 are bent, and the manufacture of the support 150 as a single piece is completed. At this point, the Z-shaped cut portion 154 has been completely manufactured, as illustrated in the lower view of FIG. 8, while the I-shaped cut portion 153 is not yet completely manufactured, as illustrated in the middle view of FIG. 7.

In the heat exchanger assembly step, the header tank 110, the tubes 120, and the support 150 are assembled. Since this step is the same as in conventional heat exchangers, the description is omitted.

In the saw-cut formation step, the remaining portion of the side portion 152 within a range of the length direction where the I-shaped hole 153a is formed is cut, and the cut portion 153b is formed. That is, by using a rotary saw machine to cut the connection portion, as illustrated in the middle view of FIG. 7, the support 150 is completely separated into two portions. This process completes the manufacture of the I-shaped cut portion 153, as illustrated in the lower view of FIG. 7.

According to the present disclosure, in a heat exchanger operating in a high-temperature environment, the shape of the saw-cut formed on the support is improved to suppress tube damage caused by the heat load, thereby improving the effect of suppressing tube damage caused by the heat load while also allowing the heat exchanger to be manufactured using existing equipment, thereby preventing an increase in the production costs. More specifically, in the present disclosure, the shape of the saw-cut formed on the support is formed of two types, an I-shaped cut portion and a Z-shaped cut portion. The I-shaped cut portion is formed at the center, and the pair of Z-shaped cut portions are formed at symmetrically opposite positions, biased toward the ends. In this case, the Z-shaped cut portion is formed to perform the same role as a saw-cut, unlike the I-shaped cut portion, even if the saw cut process is not involved. That is, the configuration of the present disclosure has the effect of increasing the number of saw-cuts, but it can be achieved using only one rotary saw machine that is typically used to manufacture a single I-shaped cut portion. As a result, according to the present disclosure, production can be carried out using only the existing facility without the need for additional facility costs, thereby effectively suppressing an increase in production costs.

The present invention is not limited to the above embodiments, and the scope of application is diverse. Of course, various modifications and implementations made by any person skilled in the art to which the present invention pertains without departing from the subject matter of the present invention claimed in the claims.

### DESCRIPTION OF REFERENCE NUMERALS

100: Heat exchanger
110: Header tank
120: Tube
150: Support
151: Bottom portion
152: Side portion
153: I-shaped cut portion
153a: I-shaped hole
153b: Cut portion
154: Z-shaped cut portion
154a: Z-shaped hole
154b: Bent portion

What is claimed is:

1. A heat exchanger, comprising:
a pair of header tanks, each having a header and a tank coupled together to form a fluid flow space inside, and spaced apart by a predetermined distance from each other to be arranged in parallel; and
a plurality of tubes, each having both ends fixed to the header tanks to form a flow path for a heat exchange medium,
wherein the heat exchanger comprises:
a pair of supports disposed on an outermost side of a tube array, which is formed by fixing both ends of the tubes to the header tanks and arranging the tubes, to support the tube array, and
wherein the support includes a single I-shaped cut portion and a plurality of Z-shaped cut portions, which separate the support into a plurality of portions.

2. The heat exchanger of claim 1, wherein the support includes:
a bottom portion extending in a length direction and formed in a plane of the length direction and a width direction; and
a pair of side portions extending in the length direction and bent from both ends of the bottom portion in the width direction toward an outside of the heat exchanger, formed in a plane of the length direction and a height direction, where an extension direction of the tubes is referred to as the length direction, an arrangement direction of the tubes is referred to as the height direction, and a direction perpendicular to both the length direction and the height direction is referred to as the width direction.

3. The heat exchanger of claim 2, wherein the I-shaped cut portion includes:
an I-shaped hole formed in the entire bottom portion and a part of the side portion; and
a cut portion formed by cutting a remaining part of the side portion within a range of the length direction in which the I-shaped hole is formed.

4. The heat exchanger of claim 3, wherein the Z-shaped cut portion includes:
a Z-shaped hole formed in the entire bottom portion and a part of the side portion; and
a bent portion formed by bending a remaining part of the side portion within the range of the length direction in which the Z-shaped hole is formed.

5. The heat exchanger of claim 4, wherein in the Z-shaped cut portion, the bent portion is bent toward an inner side of a space formed by the pair of side portions.

6. The heat exchanger of claim 4, wherein in the support, when one end of the support in the length direction is defined as 0% and the other end is defined as 100%, the I-shaped cut portion is formed at a 50% position of the support, and the Z-shaped cut portion is formed at positions symmetrical to each other in a pair with respect to the I-shaped cut portion.

7. The heat exchanger of claim 6, wherein the Z-shaped cut portion on one side of the support is formed at a position within a range of 25% to 30% of the support.

8. The heat exchanger of claim 6, wherein in the support, an inclined direction of a hole shape of the Z-shaped hole included in each of the pair of Z-shaped cut portions is either the same for both, formed as line symmetry with respect to the I-shaped cut portion, or formed as point symmetry with respect to a center of the I-shaped cut portion.

9. The heat exchanger of claim 8, wherein the inclined direction of the hole shape of the Z-shaped hole included in the Z-shaped cut portion formed on each support is formed in opposite directions, with respect to the pair of supports included in the heat exchanger.

10. The heat exchanger of claim 4, wherein a height of a part of the Z-shaped hole formed over a part of the side portion is formed smaller than a height of a part of the I-shaped hole formed over a part of the side portion.

11. The heat exchanger of claim 4, wherein a length of a part of the Z-shaped hole formed over a part of the side portion is formed greater than a length of a part of the I-shaped hole formed over a part of the side portion.

12. The heat exchanger of claim 1, wherein the heat exchanger is a radiator.

13. A method of manufacturing the heat exchanger according to claim 4, the method comprising:
a hole formation step, in which the I-shaped hole and the Z-shaped hole are formed on a flat plate including the bottom portion and the pair of side portions;
a bending formation step, in which the remaining part of the side portion within a range of the length direction where the Z-shaped hole of the support is formed is bent to form the bent portion;
a single piece completion step, in which the pair of side portions are bent, completing the manufacture of the support as a single piece;
a heat exchanger assembly step, in which the header tanks, the tubes, and the support are assembled; and
a saw-cut formation step, in which the remaining part of the side portion within a range of the length direction where the I-shaped hole of the support is formed is cut to form the cut portion.
